(19) United States
(12) Patent Application Publication
(10) Pub. No.: US 2026/0087786 A1
(43) Pub. Date: Mar. 26, 2026

(54) SYSTEM, METHOD, AND PROGRAM PRODUCT FOR OUT OF DISTRIBUTION GENERALIZATION VIA INTERVENTIONAL STYLE TRANSFER

(71) Applicants: The Trustees of Columbia University in the City of New York, New York, NY (US); The Broad Institute, Inc., Cambridge, MA (US)

(72) Inventors: Wolfgang M. Pernice, New York, NY (US); Michio Hirano, New York, NY (US); Juan C. Caicedo, Cambridge, MA (US)

(21) Appl. No.: 19/401,986

(22) Filed: Nov. 26, 2025

Related U.S. Application Data
(63) Continuation of application No. PCT/US2024/031586, filed on May 30, 2024.
(60) Provisional application No. 63/469,665, filed on May 30, 2023.
(60) Provisional application No. 63/534,027, filed on Aug. 22, 2023.

(51) Int. Cl. G06V 10/774; G06N 20/00; G06T 11/60; G06V 10/77

(52) U.S. Cl. CPC G06V 10/774; G06N 20/00; G06T 11/60; G06V 10/7715

(57) ABSTRACT

The present disclosure relates to a method for generating a training set based on a first set of images and a second set of images, each image having a respective observational environment and a respective feature set. The method includes (a) obtaining, by a generator module, the first set of images and the second set of images; (b) extracting, by the generator module, one or more feature sets from each image in the first set of images; (c) extracting, by the generator module, one or more respective observational environments from each image in the second set of images; (d) deriving, by an encoder module, one or more latent representations from the one or more feature sets extracted from one or more images in the first set of images; (e) deriving, by the encoder module, one or more style codes from the one or more respective observational environment extracted from one or more images in the second set of images; (f) generating, by the generator module, an interventional training distribution having samples including each respective one or more style codes and each one or more latent representations; and, (g) storing, by the generator module, the interventional training distribution training set.

### CROSS-REFERENCE TO RELATED APPLICATIONS

The present application is a continuation of PCT International Application No. PCT/US2024/031586, filed May 30, 2024, which claims benefit of and priority to U.S. Provisional Patent Application No. 63/534,027, filed Aug. 22, 2023, and U.S. Provisional Patent Application No. 63/469,665, filed May 30, 2023, the entire contents of each of which are hereby incorporated by reference.

### STATEMENT OF GOVERNMENT SUPPORT

This invention was made with government support under HG011488 awarded by the National Institutes of Health and 2134695 awarded by the National Science Foundation. The government has certain rights in the invention.

### FIELD

The present disclosure relates to a computer-implemented process that improves out-of-distribution generalization by means of interventional style transfer via machine learning and artificial intelligence.

### BACKGROUND

Deployment of computer vision systems in biomedical research, requires causal representations that are invariant to contextual nuisances and generalize to new data.

To enable scientific discovery, computer vision models should learn representations that generalize to observations made in new observational environments (OEs). Conventional vision systems are prone to learning spurious correlations between concepts of interest (e.g. objects) and contextual nuisances (e.g. background). This can yield biased representations that, although they may generalize well to hold-out sets that are independent and identically distributed (IID) with respect to the training data, collapse when tested on data that falls outside this distribution. For example, the performance of state-of-the-art (SOTA) vision models trained on the stereotypical views of objects in ImageNet, dramatically deteriorates when tested on ObjectNet images, which were collected with proactive interventions on several nuisance factors, such as background and object orientation (e.g. fallen-over chairs), that pose little challenge to humans.

The same confounding influence that observational environments exhibit in natural image datasets, manifests in biomedical datasets in the form of “batch effects”. Indeed, despite best efforts, technical variation between datasets collected in separate (experimental) batches cannot be perfectly controlled. Given the susceptibility of vision models to spurious correlations batch-effects present a major threat to meaningful biomedical applications of representation learning.

It would be beneficial to provide a machine learning vision model trained using a training set that avoids the problems discussed above. In particular, it would be beneficial to provide a machine learning vision model trained to identify representations that model causal relationships and are invariant with respect to observational environments.

### SUMMARY

In view of the above, it is an object of the present disclosure to provide a technological solution to address the long felt need and technological challenges faced in conventional computer vision models in which computer vision models learn spurious correlations between concepts of interest (e.g. objects) and contextual nuisances (e.g. background). In embodiments, the present disclosure relates to systems, methods, and program products that overcome this technical problem by utilizing a novel interventional style transfer system including an encoder module configured to derive a representation of an input training image, and to derive a style code of an input training image; and a generator module configured to generate an interventional training distribution training set element based on the representation and style code, wherein the deriving and generating steps are repeated for a plurality of images to provide an interventional training distribution training set including different combinations of representations and style codes. A predictor module is configured to be trained by the interventional training distribution training set, to provide computer vision.

A method for generating a training set in accordance with an embodiment of the present disclosure includes: a) obtaining, by a machine learning module, a content image and a style image; b) extracting, by an encoding module, one or more features from the content image; c) extracting, by the encoder module, an observational environment from the style image; d) deriving, by the encoder module, one or more latent representations from the one or more feature sets extracted from the content image; e) deriving, by the encoder module, at least one style code based on the observational environment extracted from the style image; f) generating, by a generator module, an interventional training distribution training set element based on the style code and the latent representation; g) storing, by the generator module, the interventional training distribution training set element in a memory operable connected to the generating module and the encoder module; and i) repeating steps a) through g) for a plurality of content images and a plurality of style images to provide an interventional training distribution training set.

A method of providing a training set in accordance with another embodiment of the present disclosure includes: a) obtaining, by a machine learning module, the set of images, wherein the set of images includes content images and style images; b) selecting, by the machine learning module, a first content image and a first style image form the set of images; c) extracting, by an encoder module, one or more feature sets from the content image and an observational environment from the first style image; d) deriving, by the encoder module, at least one latent image based on the one or more feature sets and at least one style code based on the observational environment; e) generating, by a generator module, an interventional training distribution training set element based on the at least one latent image and the at least one style code; f) storing, by the generator module, the interventional training distribution training set element in memory operably connected to the generator module; and g) repeating steps b) through f) to provide an interventional training distribution training set in the memory.

A system for providing a training set in accordance with an embodiment of the present disclosure includes: a) at least one processor; and b) a memory, operably connected to the at least one processor, the memory includes processor executable code that when executed by the at least one processor executes steps of: (i) obtaining a content image and a style image; (ii) extracting one or more features from the content image; (iii) extracting an observational environment from the style image; (iv) deriving one or more latent representations from the one or more feature sets extracted from the content image; (v) deriving at least one style code based on the observational environment extracted from the style image; (vi) generating an interventional training distribution training set element based on the style code and the latent representation; (vii) storing the interventional training distribution training set element in a memory operable connected to the generating module and the encoder module; and (viii) repeating steps (i) through (ii) for a plurality of content images and a plurality of style images to provide an interventional training distribution training set.

An interventional style transfer system in accordance with an embodiment of the present disclosure includes: memory; a machine learning module operatively connected to the memory and configured to obtain a content image and a style image; an encoding module operably connected to the machine earning module and configures to: (i) extract at least one feature set from the content image; (ii) extract an observational environment from the style image; (iii) derive a latent image representation based on at least one feature set; (iv) derive a style code based on the observational environment; a generator module operatively connected to the encoder module and configured to generate an interventional training distribution training set element based on the latent image representation and the style code, wherein the interventional training distribution training set element is stored in the memory to provide an interventional training distribution training set, wherein the interventional training distribution training set is used to train a machine learning predictor module.

Other features and advantages of the present disclosure will become readily apparent from the following detailed description and the accompanying drawings.

### BRIEF DESCRIPTION OF THE DRAWINGS

The above and related objects, features and advantages of the present disclosure will be more fully understood by reference to the following, detailed description of the preferred, albeit illustrative, embodiment of the present disclosure when taken in conjunction with the accompanying figures, wherein:

FIG. 1A illustrates an original dataset and environment in accordance with embodiments of the present disclosure;

FIG. 1B illustrates an interventional style transfer approach to impute images as if they had been collected in different observational environments in accordance with embodiments of the present disclosure;

FIG. 2 illustrates a prior art system StarGANv2 in accordance with embodiments of the present disclosure;

FIG. 3A illustrates a diagrammatic illustration of a generalized data-acquisition process for high-content microscopy in accordance with embodiments of the present disclosure;

FIG. 3B illustrates a schematic dataset substructure for a Genetics of Rare Inherited Disease dataset in accordance with embodiments of the present disclosure;

FIG. 3C illustrates a schematic dataset substructure and LINCS-SC profiling dataset respectively in accordance with embodiments of the present disclosure;

FIG. 4A illustrates an exemplary schematic of a system for providing interventional style transfer training set in accordance with an embodiment of the present application;

FIG. 4B illustrates a diagram of an exemplary interventional style transfer in accordance with embodiments of the present disclosure;

FIG. 4C illustrates results;

FIG. 4D illustrates an exemplary flowchart of a method of providing interventional style transfer training set in accordance with an embodiment of the present disclosure;

FIG. 4E illustrates an exemplary block diagram of a system of providing an interventional style transfer training set in accordance with another embodiment of the present disclosure;

FIG. 4F an exemplary flowchart of a method of providing interventional style transfer training set in accordance with another embodiment of the present disclosure;

FIG. 5 illustrates UMAPs of GRID-data training-set features extracted from the penultimate layer of predictors trained with or without IST. Colors show disease-categories Y (left) and OEs C (right).

### DETAILED DESCRIPTION

The present disclosure relates to a computer-implemented process that improves out-of-distribution generalization in an interventional style transfer via machine learning and artificial intelligence.

It is an object of the present disclosure to provide a technological solution to the long felt need in computer vision models to avoid learning spurious correlations between concepts of interest (e.g. objects) and contextual nuisances (e.g. background).

In embodiments, method for generating a training set in accordance with an embodiment of the present disclosure includes: a) obtaining, by a machine learning module, a content image and a style image; b) extracting, by an encoder module, one or more features from the content image; c) extracting, by the encoder module, an observational environment from the style image; d) deriving, by the encoder module, one or more latent representations from the one or more feature sets extracted from the content image; e) deriving, by the encoder module, at least one style code based on the observational environment extracted from the style image; f) generating, by a generator module, an interventional training distribution training set element based on the style code and the latent representation; g) storing, by the generator module, the interventional training distribution training set element in a memory operable connected to the generating module and the encoder module; and i) repeating steps a) through g) for a plurality of content images and a plurality of style images to provide an interventional training distribution training set.

In embodiments, a query may be provided to the machine learning predictor module, wherein the machine learning predictor module implements a machine learning algorithm trained using the interventional training distribution training set and generates an output associated with the latent image.

In embodiments, the latent representations are associated with phenotypic content of a cell.

In embodiments, the interventional training distribution training set is configured to identify relationships between feature sets of interest in one or more images independent of the observational environment associated with the features sets.

In embodiments the step of generating the interventional training distribution training set element includes producing, by the generator module, an image transformation including a first representation of a first image of the content image and an observational environment of a second image of the style image.

In embodiments, the first representation is first phenotypic content of a cell.

In embodiments, the step of generating the interventional training distribution training set element includes transforming, by the generator module, an appearance of a first image from a first observational environment of the first image to a second observational environment of a second image.

In embodiments, the deriving step (d) further comprises deriving, by the encoder module, one or more latent representations from the one or more feature sets extracted from content image while maintain phenotypic information.

In embodiments, the deriving step (e) further comprises deriving, by the encoder module, a style code from the respective observational environment extracted from the style image.

In embodiments, the step of generating the interventional training distribution training set element includes implementing a loss function to maintain phenotypic information.

In embodiments, the loss function is selected from a group consisting of: an adversarial loss function, a style loss function, a cycle-consistency loss function, a content loss function, and a class-matching loss function.

In embodiments the step of generating the interventional training distribution training set element includes balancing, by the generator module, content images over feature sets.

In embodiments, the step of generating the interventional training distribution training set element includes balancing, by the generator module, style images over observational environments.

In embodiments, the method includes: i) extracting, by the encoder module, second one or more features from the style image; j) extracting, by the encoder module, a second observational environment from the content image; k) deriving, by the encoder module, second one or more latent representations from the second one or more feature sets extracted from the style image; l) deriving, by the encoder module, a second style code based on the second observational environment extracted from the style image; m) generating, by a generator module, a second interventional training distribution training set element based on the second style code and the second one or more latent representations; n) storing, by the generator module, the second interventional training distribution training set element in the memory.

In further exemplary embodiments, a method for generating a training set incudes: a) obtaining, by a machine learning module, the set of images, wherein the set of images includes content images and style images; b) selecting, by the machine learning module, a first content image and a first style image form the set of images; c) extracting, by an encoder module, one or more feature sets from the content image and an observational environment from the first style image; d) deriving, by the encoder module, at least one latent image representation based on the one or more feature sets and at least one style code based on the observational environment; e) generating, by a generator module, an interventional training distribution training set element based on the at least one latent image representation and the at least one style code; f) storing, by the generator module, the interventional training distribution training set element in memory operably connected to the generator module; and g) repeating steps b) through f) to provide an interventional training distribution training set in the memory.

In embodiments, a query is provided to a machine learning predictor module implementing a machine learning algorithm trained by the interventional training distribution training set to generate an output associated with the latent image.

In embodiments, the interventional training distribution training set includes at least one image having at least one preserved representation from the first content image and at least one observational environment from the first style image.

In embodiments, the generating step includes providing an image transformation having first phenotypic content of the content image and a second observational environment of the style image.

In embodiments, the generating step includes transforming, by the generator module, an appearance of a first image of the content image from a respective observational environment to another observational environment.

In embodiments, the latent representation includes multi-layer feature-sets.

In embodiments, the style code is derived using pre-trained parameters.

In embodiments, style codes are derived from feature sets and where the feature sets are computed from the equation:

$${v}_{i} = [ ( {μ}_{{u}_{i}^{l}} , {σ}_{{u}_{i}^{l}} ) : l ∈ \{ 1 … L \} ] \qquad ( 1 )$$

where vᵢ is a style code, u are the feature sets, and

$${μ}_{{u}_{i}^{l}} and {σ}_{{u}_{i}^{l I}}$$

are the mean and standard deviation respectively across a spatial domain of feature maps of layer l.

In embodiments, wherein the encoder module is implemented as a neural network with instance normalization layers and modifications to facilitate skip connections.

In embodiments, a critic module is implemented as a multitask discriminator having a number of output heads, the number of outputs heads corresponding to a number of observational environments included in the set of images.

In embodiments, the critic module is initialized with weights of a pre-trained encoder module and fine-tuned over an adversarial optimization process.

In embodiments the weights are used to initialize the critic module.

In embodiments, image-specific style-codes are computed to steer the generator module.

In embodiments, the generating step includes minimizing a loss function to obtain the interventional training distribution training set.

In embodiments, the loss function is selected from the group consisting of: an adversarial loss function, a style loss function, a cycle-consistency loss function, a content loss function, and a class-matching loss function.

In embodiments, the generating step includes balancing, by the generator module, randomly sampled content images over labels.

In embodiments, the generating step includes balancing, by the generator module, style images over one or more observational environments.

In embodiments, the generating step includes providing the output which preserves a phenotypic content of the first content image and the observational environment of the content image.

In embodiments, an interventional style transfer system in accordance with an embodiment of the present disclosure includes: a) at least one processor; and a memory, operably connected to the at least one processor, the memory includes processor executable code that when executed by the at least one processor executes steps of: (i) obtaining a content image and a style image; (ii) extracting one or more features from the content image; (iii) extracting an observational environment from the style image; (iv) deriving one or more latent representations from the one or more feature sets extracted from the content image; (v) deriving at least one style code based on the observational environment extracted from the style image; (vi) generating an interventional training distribution training set element based on the style code and the latent representation; (vii) storing the interventional training distribution training set element in a memory operable connected to the generating module and the encoder module; and (viii) repeating steps (i) through (vii) for a plurality of content images and a plurality of style images to provide an interventional training distribution training set.

In embodiments, a machine learning module, encoder module and generator module are implemented by at least one processor based on the processor executable instructions.

In embodiments, a machine learning predictor module is operable connected to the memory and is trained using the interventional training distribution training set.

In embodiments, the step of generating an interventional training distribution training set element uses a loss function generator.

In embodiments, the loss function is selected from a group consisting of: an adversarial loss function, a style loss function, a cycle-consistency loss function, a content loss function, and a class-matching loss function.

In embodiments the content images and style images are images of tissues, cells, cell components or biological samples.

In embodiments, the content images are of cells and the cells comprise fibroblasts.

The methods disclosed herein can leverage conceptual hierarchies inherent to the data (and its corresponding generation process) for the purpose of both, generating interventions over certain levels of these hierarchies, and can also determine OOD generalization across them. In embodiments, observational environments (OEs) may constitute one, or any combination of, node(s) within a hierarchy of concepts entailed by the data, which confound one or more concepts of interest. The disclosure herein encompasses OEs based on labels that are available due to the known data generation process of single-cell microscopy datasets, in which individual observations are related by well (level-0), wherein wells are related by plate-section (level-1), wherein plate-sections are related by plate (level-2), and wherein plates are related by the experimental series during which they were prepared (level-3). However, the method and system of the present disclosure is also applicable when OEs are defined based on conceptual hierarchies for which no, or only some, labels are available, but that are inherent to the data and can therefore be defined based on suitable methods such as clustering.

An interventional style transfer system in accordance with an embodiment of the present disclosure includes: memory; a machine learning module operatively connected to the memory and configured to obtain a content image and a style image; an encoder module operably connected to the machine earning module and configures to: (i) extract at least one feature set from the content image; (ii) extract an observational environment from the style image; (iii) derive a latent image representation based on the at least one feature set; (iv) derive a style code based on the observational environment; a generator module operatively connected to the encoder module and configured to generate an interventional training distribution training set element based on the latent image representation and the style code, wherein the interventional training distribution training set element is stored in the memory to provide an interventional training distribution training set, wherein the interventional training distribution training set is used to train a machine learning predictor module to classify images.

In further exemplary embodiments, a computer system configured to generate a training set based on a first set of images. Each image includes a respective observational environment and a respective feature set. The observational environment may be associated with a background of the image but may also be associated with other features or parameters, including context, angle, lens properties and position, etc.

The disclosure herein leverages the internal replicate structure of single-cell fluorescent microscopy datasets to assess the extent to which models learn causal representations across increasingly challenging levels of out of distribution (OOD) generalization. The method and system of the present disclosure, however, may be used with other datasets as well and is not limited to use with microscopy dataset. The method and system of the present application is applicable to any datasets in which Oes can be defined, for example in RNAseq data collected in different batches, medical images collected in different hospitals images, and even traffic videos from different locations, to name a few. Despite seemingly strong performance as assessed by other established metrics, both naive and contemporary baselines designed to ward against confounding, collapse to no better than random performance on these tests. The present disclosure is directed to a novel and non-conventional interventional style transfer model, that substantially improves OOD generalization by generating interventional training distributions in which spurious correlations between biological causes and nuisances are mitigated. In embodiments, the interventional style transfer model disclosed herein learns augmentations that imitate the effect of confounders.

Causal inference may be used to study the batch effects of observational environments as a confounder C. A general causal process describes most datasets in biology. It is an object of the present disclosure to learn representations from data, that model causal relationships, while remaining invariant to observational environments.

In embodiments, the hypothesis that a given representation that is invariant over observational environments and nuisances cannot be falsified using IID hold-out data. A rigorous testing regime based on generalization to observational environments (OEs) which are OOD compared to the training data is a necessary characteristic and critical empirical measure of causal learning.

To this end, two real-world single-cell fluorescent microscopy datasets that exhibit internal replicate structures representative of most high-content imaging protocols (see below) are released. This substructure is leveraged to design realistic OOD generalization tasks. It is determined that naive and state-of-the-art post-processing and regularization baselines designed to mitigate batch-effects and/or improve OOD generalization, fail when evaluated to test OOD tasks, despite in part excellent scores on independent and identically distributed hold-out sets and auxiliary metrics.

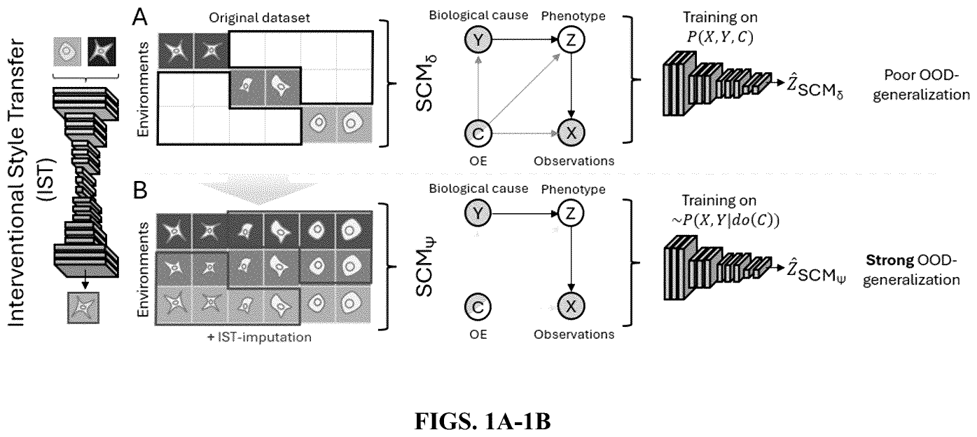

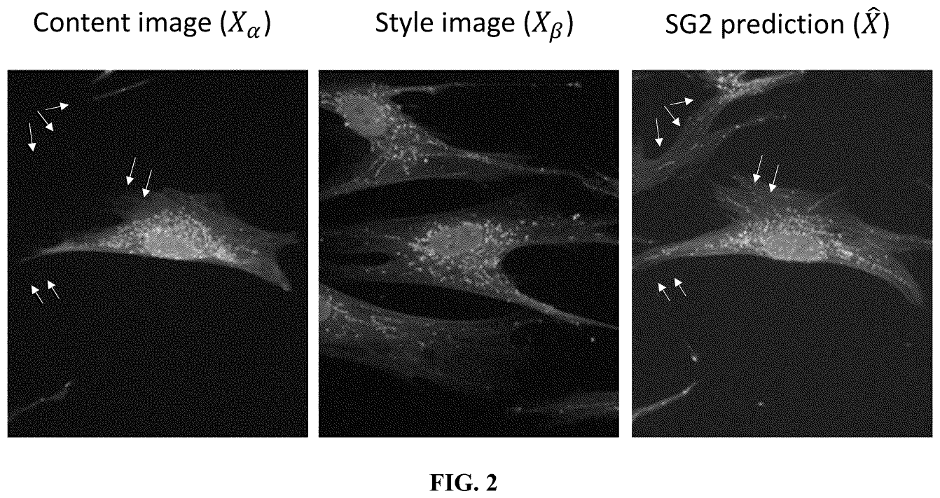

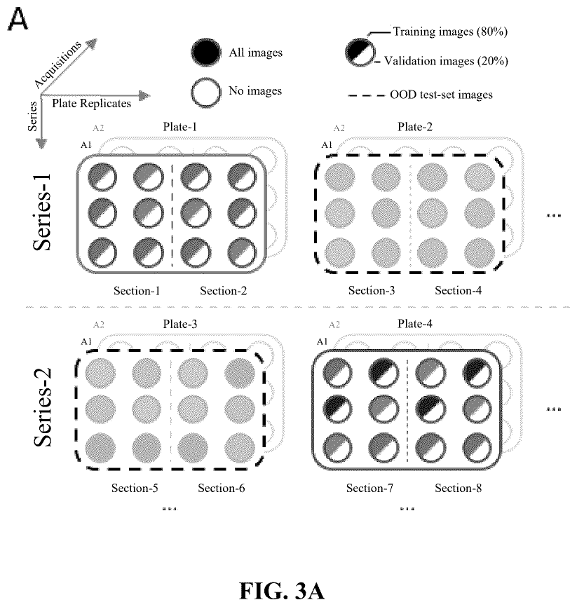

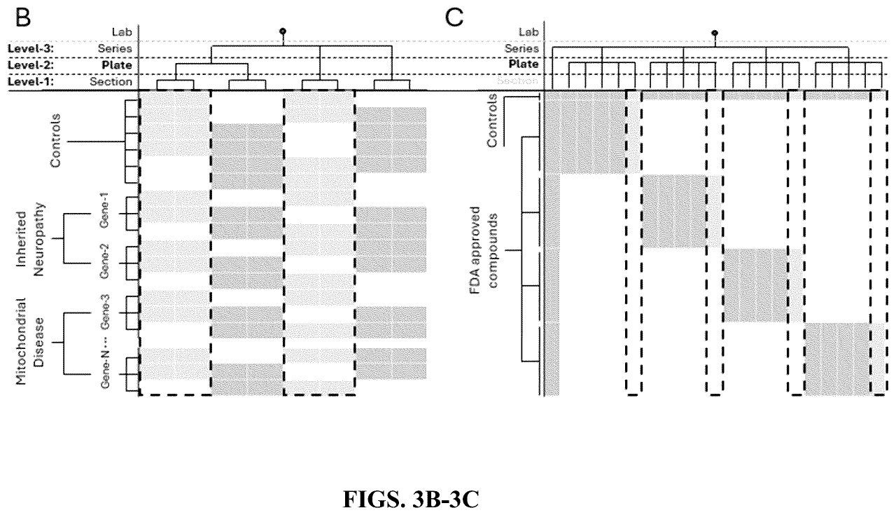

In embodiments, given the ineffectiveness of prior art methods in OOD tests, intervening on the training distribution itself is considered. Most prior art high-content imaging datasets are sparse, that is, sets of conditions are only observed in some OEs but not others (as shown in FIGS. 1A, 1B and FIG. 3). It is an object of the present disclosure to propose a new, light-weight method for interventional style transfer that generates effective interventions across an arbitrary number of observational environments. To achieve this, architectural innovations and loss terms are disclosed herein that prevent content hallucinations, which lead to failure of other prior art style-transfer methods using on benchmark datasets. A novel and non-conventional interventional style transfer model is disclosed to yield a training distribution that mitigates observational environments as confounders (as shown in FIGS. 1A and 1B) and show that models trained on the interventional style transfer method exhibit major improvements in out of distribution generalization.

The present disclosure provides two new benchmark single-cell datasets with different degrees of sparsity in their replicate structure. Furthermore, a rigorous OOD generalization testing regime that can be adopted across most experimental datasets. The interventional style transfer model is provided herein as the first method that achieves substantial improvements across increasingly challenging levels of out of distribution generalization.

Prior art data augmentations, such as blur, contrast, and rotations, are almost universally used in computer vision to yield more robust models. Both style-transfer and adversarial training have been employed in the pursuit of more complex augmentations. In embodiments, the interventional style transfer model disclosed herein learns augmentations that imitate the effect of confounders.

Generative models have been employed on fluorescent microscopy and other biomedical data. When observational environments are unobserved, generative models may be steered to produce noisy image manipulations on complex nuisances such as view point, that, when employed during training, improve OOD generalization. In embodiments, the interventional style transfer model disclosed herein employs the known replicate structure of the datasets to steer the generator directly.

A major risk in applying prior-art style-transfer methods to scientific data is the inadvertent alteration of content. In embodiments, the content at risk is phenotypic information. In embodiments, the present disclosure allows for the differential manipulating of a style while preserving other content. In embodiments, the interventional style transfer model disclosed herein emphasizes content-preservation by discouraging major changes in pixel space.

In embodiments, the interventional style transfer model employs style-transfer to disentangle batch effects from biological features. In embodiments, the interventional style transfer model features architectural improvements that prevent content alterations without the need for threshold or segmentation-based regularization terms. The interventional style transfer model of the present disclosure also does not depend on assumptions about the nature of batch-effects (such as that they primarily manifest in first-order statistics), and achieves strong performance on challenging benchmarks without the need for additional post-hoc methods.

FIG. 1A illustrates an original dataset and environment. In most high-content datasets, all conditions are not observed in all observational environments. Training distributions based on these datasets thus entail spurious correlations between observational environments, observations and biological causes, yielding models that learn confounded representations according to structural causal model SCM^{δ}.

FIG. 1B illustrates an interventional style transfer approach to impute images as if they had been collected in different observational environments. Randomly permuting images across observational environments yields an interventional distribution that avoids spurious correlations with observational environments allowing models to learn representations that are less biased and better capture the true causal structure according to structural causal model SCM_{ψ}.

FIGS. 1A and 1B illustrate a generalized structural causal model SCM. As explained in further detail below, causal relationships between a set of conditions Y may manifest cellular phenotypes Z. In some embodiments, the set of conditions are disease categories. To characterize cellular phenotypes Z, observations X are collected using fluorescent microscopy.

In embodiments, observations X are made in specific observational environments OEs that introduce technical variation to observations X, and may further influence the biology of the cellular phenotypes Z, revealing it as a confounder C. In embodiments, the observational environments C are batches, constituted by a specific well, plate, aliquot of reagents and the like.

As noted above, in most datasets, not all conditions, such as biological causes, are observed in all observational environments. In embodiments, the specific observational environment C also determines the set of biological causes Y. By way of example, two plates may contain different sets of conditions Y. Given training distributions P(X,Y,C) in which biological causes Y are sparse over observational environments C, discriminative models learn spurious correlations between biological causes Y and confounding observational environments C according to a structural causal model SCM_{δ} resulting in biased representations of cellular phenotypes \hat{Z}_{SCM}_{_{δ}} that generalize poorly to new observational environments as shown in FIG. 1A. That is, predictive models that are trained using training sets in which biological causes Y are sparse over the observational environments may improperly attribute aspects of the observational environment as biological causes.

In embodiments, the interventional style transfer method disclosed herein produces faithful imputations of source images from an observational environment as if the imputations of source images had been collected in a different observational environment, which allows for the approximation of interventional distribution P(X, Y|do(C)) that eliminates the backdoor paths emanating from specific observational environments C, removing observational environments as a confounder.

The interventional style transfer model described herein utilizes an interventions-based approach that is compatible with experimental datasets. Importantly, in most prior-art natural image data-generator processes, observations cause labels, or stated differently, human experts label images according to what is observed. The interventional style transfer model is trained to recapitulate this ability. In the interventional style transfer model, Y represents sets of conditions that may cause observable cellular phenotypes. The conditional distribution P(Y|X) is approximated, that is to estimate the cause Y given noisy observations X, enabling biologically meaningful representations of a prior unknown phenotypes Z to be determined.

Second, in contrast to natural images, where observational environments are generally unobserved, experimental data-acquisition protocols provided herein inherently document a rich ontology of processing steps that lead to any particular image (as explained in further detail below with reference to FIG. 3A). Observational environments are thus systematically tracked and feature rich metadata through which confounder C is partially observed. The interventional style transfer model described herein explicitly steers the data generator process learned by the interventional style transfer model according to the known observational environment structure of the datasets. By using the interventional style transfer model to intervene on confounder C, the interventional style transfer model mitigates spurious correlations in the training distribution, yielding \hat{Z}_{SCM}_{_{ψ}} and representations that generalize to OOD data (as shown in FIG. 1B).

FIG. 3A illustrates a diagrammatic illustration of a generalized data-acquisition process for high-content microscopy, where well colors indicate conditions, such as cell lines or perturbations, arrayed over multiwell plates with limited capacity. Datasets exhibit a nested replicate structures; and a series constitutes a full experimental replicate including fresh cells and reagents, which may contain further replicates by plate, plate-section, which in embodiments is acquired separately, and acquisitions, each constituting potentially meaningful observational environments. This yields datasets of varying degrees of sparsity.

FIGS. 3B and 3C illustrate schematic dataset substructure for a Genetics of Rare Inherited Disease dataset and a LINCS-SC dataset respectively. Levels of generalization are defined according to increasingly distant relationships between observational environments. In the figures, the training and out of distribution test setup for one-fold of level-2 is indicated.

A neural style transfer method performs image transformations that preserve spatial content while adjusting other feature statistics as desired. In order to generate effective interventions on confounder C, a style-transfer model learns to specifically transfer features related to observational environments, while preserving phenotypic content.

As shown in FIG. 2, prior art system StarGANv2 utilizes a single encoder-decoder architecture capable of style-transfer between an arbitrary number of style-domains, such as demo-graphic categories. StarGANv2 of FIG. 2 introduces both subtle and more obvious content alterations (as illustrated with white arrows). The present interventional style transfer model generates images in the “style” of specific observational environments. The outputs consistently feature both subtle and more obvious content hallucinations (as shown in FIG. 2), suggesting that StarGANv2 fails to adequately preserve phenotypic content. Prior art system MixStyle, in an alternative to style-transfer in pixel space pursues domain-generalization by mixing style-features of images from different observational environments in the feature-maps of hidden-layers during training. This avoids the need for a generator all together.

However, these prior art systems assume that computing mean and standard-deviation of the feature-maps is sufficient to adequately capture style. While this may hold to some extent for natural images, there are no guarantees that this is true for batch-effects in microscopy data, and MixStyle offers little-to-no benefit.

To avoid these failure modes, the systems and methods of the present disclosure provide an interventional style transfer model. Specifically, to enforce content preservation, the systems and methods of the present disclosure provide introduce skip-connections between bottle-neck layers of our encoder and decoder, and introduce three complementary loss terms that discourage phenotypic alterations. Second, although first-order feature-map statistics are by themselves insufficient to describe observational environments, they suffice as style-codes that, when injected into Adaptive Instance Normalization (AdaIN) layers, may be interpreted by the decoder described herein to generate output images across an arbitrary number of observational environments which avoids all auxiliary networks required by prior art StarGANv2 or comparable methods, rendering the interventional style transfer model not only effective, but also computationally efficient, as detailed below.

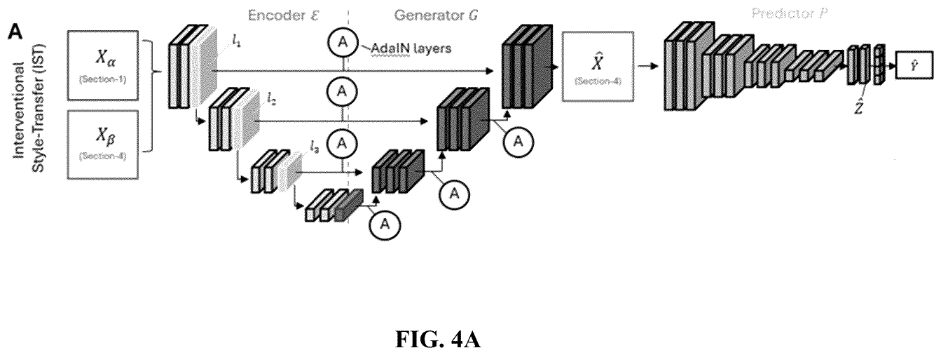

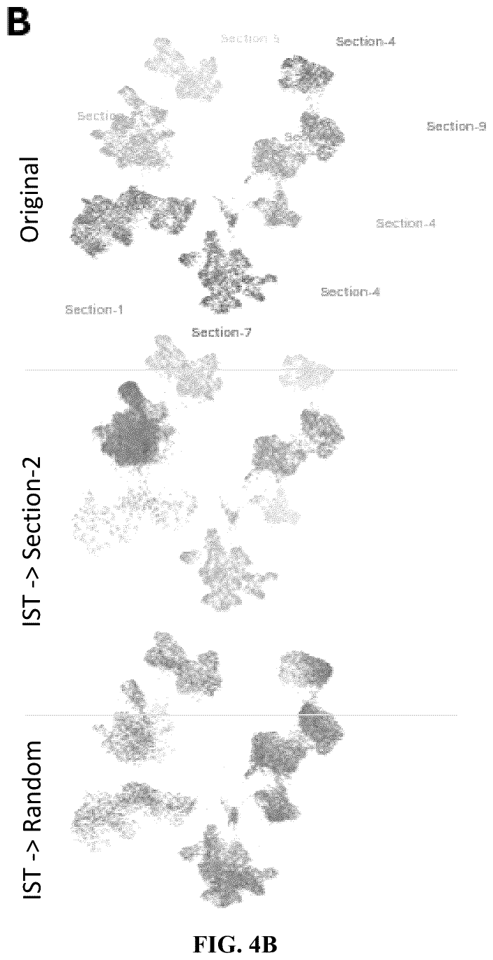

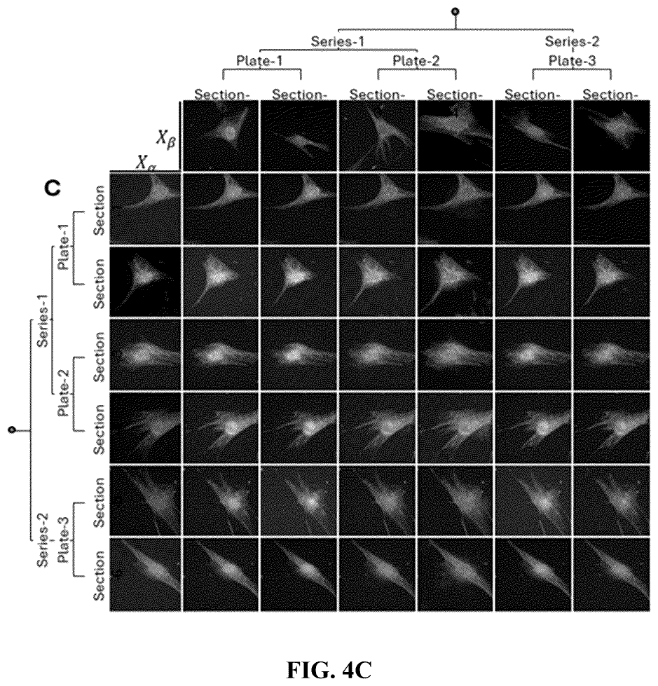

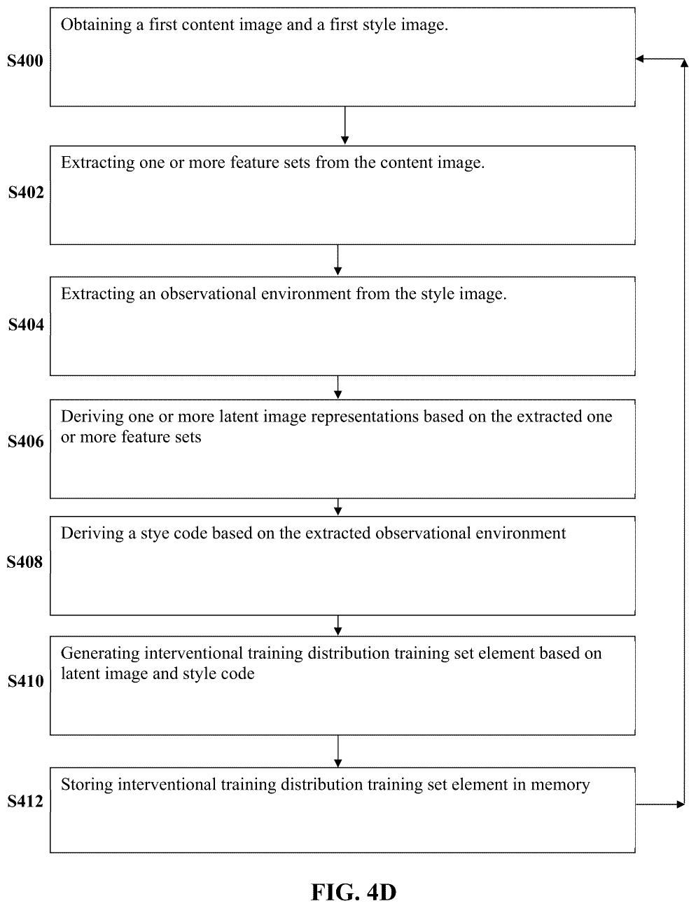

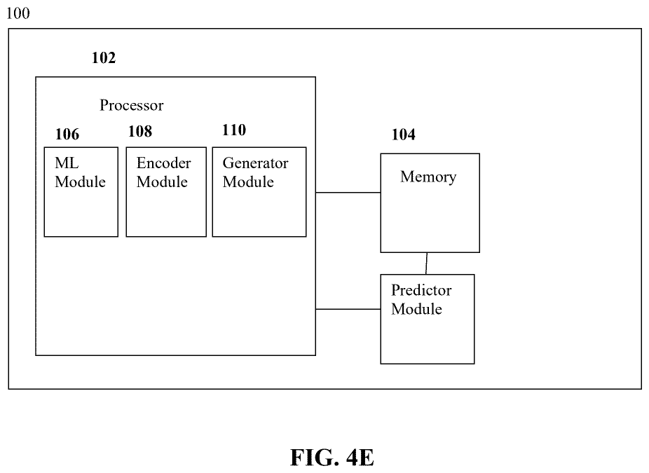

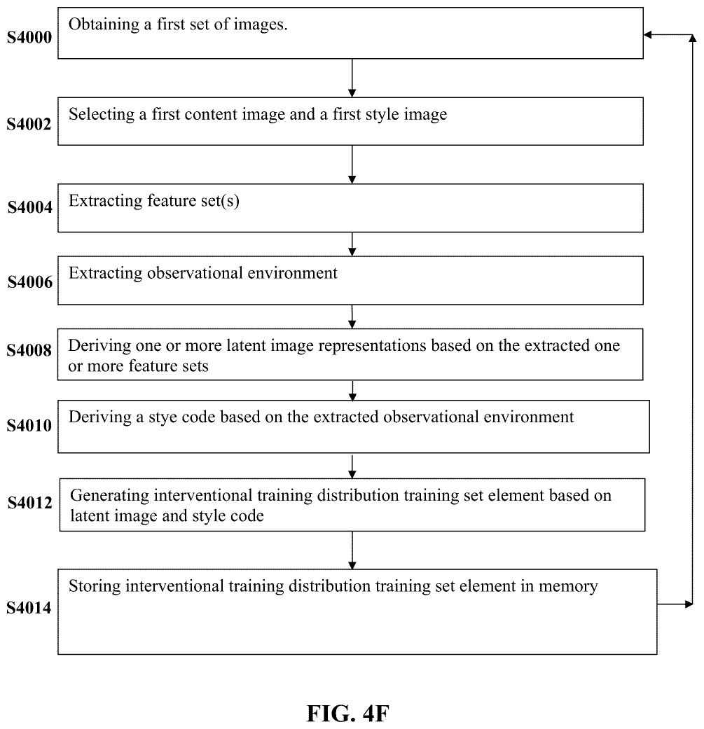

FIG. 4A illustrates a diagram of an exemplary interventional style transfer method and associated interventional style transfer model in accordance with an embodiment of the present disclosure. In embodiments, given content image x_{α} and style image x_{β}, encoder E extracts latent representations u_{α} and provides it to a generator G. In embodiments, encoder E further extracts style-codes v from image x_{β} and provides them to generator G via AdaIN layers. In embodiments, an output \hat{x} is yielded that preserves the phenotypic content of x_{α} but inherits the observational environment of x_{β}. In embodiments, predictors P are trained on the resulting data distribution \hat{X}. FIGS. 4B and 4C illustrate UMAPs and output images illustrating the capacity of the interventional style transfer to project images into specific batches. In embodiments, when x_{β} is sampled from a specific observational environment, output images fall onto their expected landmark in the UMAP space computed on the pretrained representations of encoder E as explained in further detail below. In embodiments, when sampling x_{β} fairly from all training observational environments, the resulting distribution \hat{X} is randomized over all observational environments.

In embodiments, to train the interventional style transfer model, X is a set of images, with associated environments C and cause labels Y, respectively. Given an image x∈X observed in environment c∈C, the generator G is trained and capable of producing image transformations \hat{x} as if they come from other environments C (style) while preserving the original phenotypic content z∈Z. To this end, in embodiments, style codes v are derived and generator G interprets them.

As shown in FIG. 4A, the framework consists of three main modules. In embodiments, given an image x, the encoder E derives the representation uₓ=E(x), composed of multi-layer feature-sets uₓ^{l}, with l∈{1 . . . , L} and L the number of layers in the network. In embodiments, Encoder E is implemented as a ResNet18 with instance normalization layers and modifications to facilitate skip connections. In embodiments, encoder E is pre-trained on an auxiliary multi-task objective of predicting associated environments C and labels Y given the set of images X. In embodiments, the encoder may be implemented using another neural network.

In embodiments, the generator G predicts output images \hat{x}=G(u,v) given a feature set u and a style code v. To promote the preservation of phenotypic content in the output images, in embodiments, generator G is biased against major changes in pixel space, by implementing generator G as a UNet-decoder with skip connections that concatenate feature-sets uₓ^{l} from the l-th corresponding feature-layer of the encoder E, with l∈{1 . . . , L}. This improves both similarity between pairs x and \hat{x} as well as the realism of our output images. The generator G repeats this prediction for a plurality of content images and style images, based on the feature sets and style codes associated therewith.

FIG. 4D illustrates an exemplary flowchart of a method of providing a training set or the machine learning predictor P in accordance with an embodiment of the present disclosure. In embodiments, the method of FIG. 4D may be implemented via a computer system 100 such as that illustrated in FIG. 4E. In embodiments, the computer system 100 may include a processor 102 operatively connected to a memory 102. In embodiments, processor 102 may include 1 or more processors. In embodiments, the processor 102 may be part of a server on a network or may be provided in a PC, laptop computer or mobile computer system. In embodiments, the processor 102 may be operatively connected to memory 104, In embodiments, the memory may be a database or any suitable memory. In embodiments, the memory 104 may be a cloud based storage system. In embodiments, the memory 104 may include, among other things, processor executable code that when executed by the processor 102, cause the processor to execute the steps of FIG. 4D. In embodiments, the processor executable code may be executed by the processor to implement a machine learning module 106, an encoder module 108 and a generator modules 110. In embodiments, the encoder module and generator module may be implemented in or by the machine learning module 106. In embodiments, a machine learning predictor module 112 may also be implemented using the processor executable instructions. In embodiments, the predictor module 112 may be implemented via processor executable code stored in another memory, operably connected to the predictor module.

In embodiments, at step S400, a machine learning module 104 may obtain a first content image and a first style image. In embodiments, the first content image may be one of a plurality of content images and the first style image may be one of a plurality of content images. In embodiments, the first content image and the first style image may be stored in the memory 102. In embodiments, the memory 102 may be provided locally or remotely. In embodiments, the first content image may be the image x_{α} discussed above and the first style image may be the image x_{β}. In embodiments, at step 402, encoder 108 may be used to extract one or more feature sets from the first content image. In embodiments, the encoder module 108 may be or perform the function of the encoder E discussed above. In embodiments, the feature sets may be associated with objects in the first content image. In embodiments, at step S404, the encoder 108 may be used to extract an observational environment from the first style image. In embodiments, the observational environment of the style image is different than that of the content image. In embodiments, in step S406, the encoder 108 derives a latent image representation associated with the feature set or sets. In embodiments, in step S408, the encoder 108 derives a style code associated with the observational environment extracted. In step S410, the generator module 110 generates an interventional training distribution training set element based on the latent image representation and the style code. In embodiments, the generator module 110 may correspond to the generator G discussed above. In embodiments, in step 412, the interventional training distribution training set element may be stored in memory 102 to provide an interventional training distribution training set. In embodiments, steps S400 to 412 are repeated with additional content images and style images to provide a plurality of interventional training distribution training set elements to populate the interventional training distribution training set.

In embodiments, the method of FIG. 4D may be repeated with the first content image and first style image reversed such that one or more feature sets are extracted from the first style image and the observational environment is extracted from the first content image in steps S402 and S404. The process then proceeds to provide a second interventional training distribution training set element that is stored in the memory and added to the interventional training distribution training set. The interventional training distribution training set is used to train the predictor module P to train a machine vision machine learning algorithm. In embodiments, the method of FIG. 4D may be repeated with a plurality of content images and style images to provide a plurality of interventional training distribution training set elements which are used as the interventional training distribution training set used to train the machine learning predictor.

FIG. 4F illustrates another embodiment of the method for providing a training set for a machine learning predictor. In embodiments, in step S4000, a machine learning module obtains a set of images, wherein the set of images includes content images and style images. In embodiments, in step S4002, a first content image and a first style image are selected from the set of images, by the machine learning module 106, for example. In embodiments the machine learning module 106 may be implemented by the processor executing processor executable code. In embodiments, one or more feature sets may be extracted from the content image by the encoder module 108, for example in step S4004. As noted above, the encoder module may be implemented using processor executable code executed by the processor 102. In embodiments, at step S4006, an observational environment is extracted by the encoder. At step S4008, a latent image representation is derived from the feature sets by the encoding device and in step S4010, a style code is derived based on the observational environment. At step S4012, the generator module 110 may be used to generate an interventional training distribution training set element based on the latent image representation and the style code. At step S4014, the interventional training distribution training set element may be stored in the memory 106, for example. The method of FIG. 4F may also be repeated for all of the images in the first set of images to provide an interventional training distribution training set.

In embodiments, a critic D may be implemented as a multitask discriminator with N_{c} output heads, where N_{c} is the number of observational environments. In embodiments, each head D_{c} is trained as a binary classifier to distinguish real from fake images of their true or assigned observational environments C. To facilitate convergence, in embodiments, critic D is initialized with the weights of the pre-trained encoder E and fine-tune over the adversarial optimization process.

In embodiments, the machine learning module 106, encoder module 108 (encoder E) and generator module 110 may be implemented by the processor 102 based on instructions provided by the memory 104. In embodiments, the machine learning module 106, encoder module 108 and generator module 110 may be separate devices or may be implemented by processor executable instructions in another memory.

In embodiments, image-specific style-codes are computed to steer the generator G. Unlike prior art methods and systems (such as StarGANv2) which employ a dedicated style-encoder to derive style-codes from latent distributions or input images, effective style-codes can be computed directly from image features using the pre-trained, frozen encoder E. Given the features uᵢ=E(xᵢ) of an image xᵢ, where uᵢ is defined as:

$${v}_{i} = [ ( {μ}_{{u}_{i}^{l}} , {σ}_{{u}_{i}^{l}} ) : l ∈ \{ 1 … L \} ] \qquad ( 1 )$$

$$where {μ}_{{u}_{i}^{l}} and {σ}_{{u}_{i}^{l I}}$$

are the mean and standard deviation respectively across the spatial domain of the feature maps of layer l.

In embodiments, generator G is trained to transform the appearance of an image from one observational environment to another. In embodiments, following pre-training, the encoder E is frozen and weights from the encoder E are used to initialize the critic D. In embodiments, the generator G is trained using stochastic gradient descent (“SGD”) on pairs of triplets: (x_{α}, y_{α}, c_{α}) for content images and (x_{β}, y_{β}, c_{β}) for style images. During training, randomly sampled content images are balanced over labels Y, and style images are balanced over C. In that way, content and style images are independently drawn to ensure samples with diverse phenotypic and technical variation respectively. In embodiments, during the forward pass, feature sets uₐ=E(x_{α}) and u_{β}=E(x_{β}) are computed to then derive style codes vₐ, v_{β}. To intervene on the observational environment of the content image, v_{β} is injected using AdaIN-layers to predict the output images \hat{x}=G(E(x_{α}),v_{β}). The following training objectives are minimized:

In embodiments, given a pair of content and style images xₐ, x_{β}, style-codes vₐ, v_{β} are computed as described above. The generator is trained to produce realistic output images \hat{x}=G(E(x_{α}),v_{β}) with the following adversarial loss defined as:

$${ℒ}_{Adv} = {𝔼}_{x , c} [ log ( {𝒟}_{c} ( x ) ] + {𝔼}_{x , \overline{x} , \overline{c}} [ log ( 1 - {𝒟}_{\overline{c}} ( 𝒢 ( ℰ ( x ) , {v}_{\overline{c}} ) ) ) ] , \qquad ( 2 )$$

where D_{c}(⋅) is the head corresponding to observational environments c. Generator G learns to use the style-codes v_{\tilde{c}} to generate versions of x as if observed in another environment \tilde{c}.

Effective intervention is ensured by applying a style-loss defined as:

$${ℒ}_{Style} = {E}_{\hat{x} , c} [ \frac{1}{L} {\sum }_{l = 1}^{L} {‖ Gram ( {u}_{x}^{l} ) - Gram ( {u}_{\hat{x}}^{l} ) ‖}_{1} ] \qquad ( 3 )$$

where Gram(⋅) denotes the Gram matrix of features in the l-th layer of the encoder E, used in style transfer to match the feature covariance of stylized images.

To promote the preservation of phenotypic content of a source image x_{α} in the output \hat{x}=G(E(x_{α}),v_{β}). A cycle-consistency loss defined as:

$${ℒ}_{Cyc} = {𝔼}_{x , c} [ {‖ x - 𝒢 ( ℰ ( \hat{x} ) , {v}_{c} ) ‖}_{1} ] , \qquad ( 4 )$$

where v_{c} is the estimated style code of the original content image, i.e. we reconstruct x_{α} from output \hat{x}.

Additionally, in embodiments, the absolute changes in pixel space between x and \hat{x} are constrained to prevent substantial loss or addition of phenotypic content (e.g. the hallucination of new cells or cellular components) by applying a content loss defined as:

$${L}_{Cont} = [ {‖ ( \hat{x} - x ) ‖}_{1} + \frac{1}{L} {\sum }_{l = 1}^{L} {‖ {z}_{\hat{x}}^{l} - {z}_{x}^{l} ‖}_{1} ] \qquad ( 5 )$$

In embodiments, to further enforce that the generator preserves the phenotypic characteristics of input images, a class-matching loss is implemented and is defined as:

$${ℒ}_{𝒞 match} = {𝔼}_{\overline{x}} [ - {\sum }_{y ∈ Y} \hat{y} log ( {{ℰ}_{cmt} ( \hat{x} )}_{y} ) ] , \qquad ( 6 )$$

which is essentially the cross entropy loss of the cause predictions for the synthesized image with respect to the predictions for the real input image, according to the frozen encoder classifier E_{cls} Note that instead of using the actual cause label y, we use as target the prediction for the real image ŷ=E_{cls}(x_{c})_{y}).

A min-max objective that trains the generator and critic in an adversarial fashion is then optimized and defined as:

$${min}_{𝒢} {max}_{𝒟} = {ℒ}_{Adv} + {λ}_{1} {ℒ}_{Style} + {λ}_{2} {ℒ}_{Cyc} + {λ}_{3} {ℒ}_{Cont} + {λ}_{4} {ℒ}_{Cmatch} , \qquad ( 7 )$$

where λᵢ∈R are hyperparameters of the loss terms.

In embodiments, once the interventional style transfer model is trained, it is employed to generate an interventional training distribution P(\hat{X},Y|do(C)) naïve, on which in turn predictor network P is trained as shown in FIG. 4A. To produce \hat{X} during predictor training, content x_{α} and style x_{β} images are sampled from the training distribution by pairing random causes with random observational environments (both drawn uniformly) and passed through the (frozen) Interventional style transfer model. This breaks the spurious correlations between biological causes and observational environments present in the original datasets. During testing, test images are processed through the Interventional style transfer model by randomly pairing the test images with a training image. This can be interpreted as bringing unseen images to familiar observational environments for analysis, and we observed that interventional style transfer-trained predictors perform better using this additional test-time correction.

### Experimental Data

To evaluate the merits of the interventional style transfer method and associated Interventional style transfer model in causal representation learning compared to relevant contemporary baselines, we conduct experiments on two novel single-cell microscopy datasets that exhibit different degrees of sparsity and correlation between biological causes and observational environments (as shown in FIGS. 3B and 3D). Based on the known observational environment substructure in these dataset, three increasingly challenging levels of out of distribution-generalization are empirically assessed, by constructing hold-out sets according to a hierarchy of processing steps that separate them from the training data (as shown in FIG. 3A-3D).

Although the experimental data provides details on biological causes for context, the results are not interpreted with respect to associated biological implications. The experimental data is directed to testing the generality of models across observational environments.

A subset of the Genetics of Rare Inherited Disease (GRID) dataset is published and is collected to discover latent disease-associated phenotypes in primary patient cells. The dataset contains 17,030 fluorescent microscopy images that reveal the organelle structure of primary dermal fibroblasts derived from 19 patients with 8 genetically confirmed inherited mitochondrial or neuromuscular diseases, and healthy controls as shown in FIG. 3B. Data was acquired in multi-well plates with a hierarchical replicate structure: images were collected within the minimal observational environment of individual wells that contain cells of a specific cell-line. Images of the same cell-lines were collected in multiple (replicate) wells, organized into plate-sections, plates, and series as shown in FIGS. 3A and 3B. Replicate wells across sections (level-1) are seeded onto the same plate, during the same tissue culture session and derive from the same source cultures. Plate-level replicates (level-2) are separated by plate, but share source cultures. Finally, series (level-3) indicate full experimental replicates, starting with fresh thaws of cells. Critically, while sections contain identical sets of cell-lines, they only partially overlap be-tween plates and series, yielding a sparse matrix of biological causes vs. observational environments (FIG. 3B).

In contrast to GRID, the LINCS Cell-Profiling dataset was collected as a pharmacological perturbation study, including 1,327 clinically relevant compounds, using a single A549 lung cancer cell line. Cells were stained according to the Cell-Painting protocol and imaged at lower magnification, such that the resulting images contain many cells. The LINCS single-cell (LINCS-SC) dataset, contains a subset of 101 compounds with strong morphological effects as judged by prior analyses. Single-cell images were derived by segmenting source images with Cell Profiler for a total of 200,000 images.

In contrast to GRID, LINCS plates contain no sections. Moreover, LINCS plate- and series-level replicates are structured according to 25 unique plate-maps that host exclusive perturbations: with the exception of controls, there is no overlap between compounds across plate-maps. Consequently, the data-matrix is almost perfectly sparse between plate-maps as shown in FIG. 3C. Finally, in LINCS, only one series contains all plate-maps (i.e. treatments), but without plate-level replicates, while four additional series contain exclusive subsets of plate-maps, each replicated 5 times (FIG. 3C).

In embodiments, predictors P are trained such that the predictors P generalizes to unseen observational environments. The interventional style transfer model is compared to strong domain-specific and more general baselines that collectively represent three major categories: post-hoc correction in feature space, regularization during training, and interventions on the training distribution. For all experiments, the same set of pre-processing steps and augmentations are used. As a naive baseline, the predictor P is randomly initialized as a ResNet18 network (using IN layers) attached to a linear classification head and train it to predict biological causes Y from \hat{X}. In embodiments, other neural networks may be used. The following methods are implemented via minimal necessary deviations:

Prior art Symphony (SYM) is a state-of-the-art batch-effect correction method developed for single-cell RNA-sequencing (scRNAseq) datasets. Symphony extends a previous method, prior art Harmony, which learns linear corrections over labeled nuisances. In contrast to Harmony, Symphony allows for inference on unseen datasets. Symphony is fit on training-set features \hat{Z} extracted from our naive baseline. A topn hyperparameter is set as equal to the feature-dimension of the interventional style transfer model and empirically tune others.

Domain-adversarial training is compared against the interventional style transfer model as a regularization technique to learn features that discriminate classes but are invariant to domain-shifts between datasets. To allow for multiple domains (observational environments), the architecture of the naive baseline by adding a second classification-head that distinguishes observational environments. During backpropagation, a gradient-reversal layer is employed to invert the gradient emanating from the observational environment-classifier for all layers in the shared ResNet18 stem. As noted above, in embodiments, other neural networks may be used. A gradient-reversal hyperparameter λ is tuned by grid-search to optimize validation accuracy on Y, while minimizing performance on C.

StarGANv2 is assessed (as a state-of-the-art style-transfer method in natural images. We train using default parameters over 75 k iterations. We sample content and style image pairs are sampled for the interventional style transfer model and use observational environment-labels Y as domains in StarGANv2's multi-task discriminator. Following training, we use StarGANv2 in the same way as the interventional style transfer model, to project input images to random observational environments, in the hope to yield an interventional training distribution free of spurious correlations.

MixStyle is assessed as a second recent style-transfer baseline that was specifically developed for domain generalization. MixStyle is implemented in the predictor architecture and successfully recapitulated the results of MixStyle on PACS using the interventional style transfer model. For fairer comparison to the interventional style transfer model, MixStyle is tested in a domain adaptation setup, in which MixStyle is trained on styles (but not biological causes Y) of images from test observational environments.

### Evaluation Metrics

To test out of distribution-generalization, section-, plate-, or series-wise cross-validation (levels of generalization as shown in FIG. 3) is performed by testing predictors on observational environments that were left out during training. Qualitative, feature-space visualizations are widely used in the biomedical literature. Uniform Manifold Approximation and Projection (UMAPs) are reported. A ratio of observational environment (bLISI) to cause-wise (cLISI) scores is used, and normalized over the cardinality |C| and |Y| respectively, to quantify local diversity in feature space. Ideally, bLISI=1, while cLISI=1/|Y|. kNN-CV: as a second feature-space based metric, the out of distribution-generalization experiments are simulated by evaluating kNN-classifiers on predicting cause-labels for validation-set images from observational environments the corresponding training set images of which are left out of the kNN-reference set.

Table 1 illustrates macro f1 and LISI scores on predictor performance on GRID and LINCS-SC; and kNN-based classification results for Symphony vs. baseline.

| | IID | cLISIS/bLISI | kNN BatchCV | Level-1 | Level-2 | Level-3 |
|---|---|---|---|---|---|---|
| Baseline | 0.55 | 0.5417 | 0.4458 | 0.1877 | 0.1381 | 0.1254 |
| baseline kNN | 0.63 | 0.5417 | 0.4458 | 0.1838 | 0.1378 | 0.1317 |
| Symphony kNN | 0.50 | 0.7340 | 0.4404 | 0.1797 | 0.1474 | 0.1325 |
| DR α = 0.0625 | 0.73 | 1.0811 | 0.6906 | 0.1900 | 0.1379 | 0.1259 |
| MixStyle-DA | 0.80 | 0.6039 | 0.5519 | 0.1084 | — | — |
| StarGANv2 | 0.20 | 1.099 | 0.1539 | 0.1659 | 0.1284 | 0.0977 |
| IST (ours) | 0.60 | 1.4963 | 0.5815 | 0.5839 | 0.5350 | 0.3673 |

| | IID | kNN BatchCV | Level-1 | Level-2 | Level-3 |
|---|---|---|---|---|---|
| baseline | 0.57 | 0.1271 | NA | 0.4194 | 0.0405 |
| baseline kNN | 0.55 | 0.1271 | NA | 0.3897 | 0.0452 |
| Symphony kNN | 0.35 | 0.1098 | NA | 0.2697 | 0.0461 |
| DR-0.0625 | 0.56 | 0.1381 | NA | 0.4256 | 0.0438 |
| MixStyle | 0.41 | Nc | NA | 0.4429 | 0.0450 |
| StarGANv2 | nc | nc | NA | nc | Nc |
| IST (ours) | 0.53 | 0.3304 | — | 0.7016 | 0.3138 |

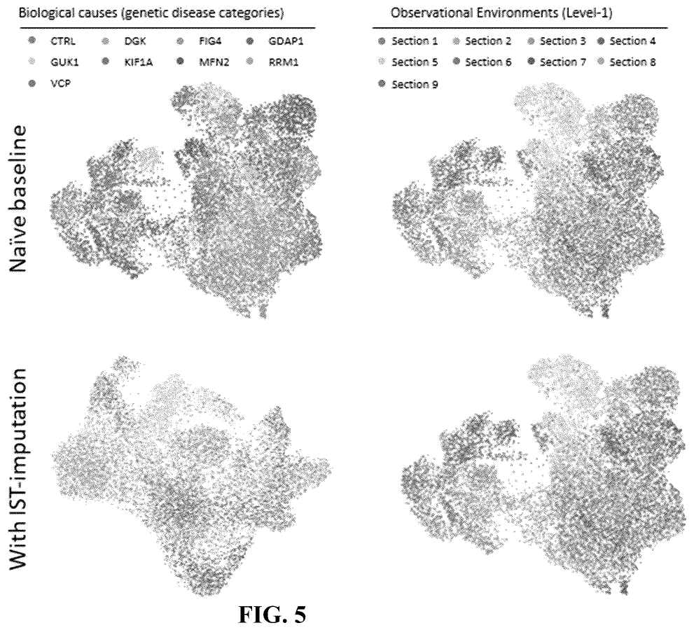

The empirical results for the interventional style transfer model and all baselines for GRID are validated on LINCS-SC as shown in Table 1. Trained across all observational environments, the naive baseline achieves excellent performance on independent and identically distributed hold-out data, and therefore suggest there exist robust phenotypic manifestations of inherent genetic (GRID) and pharmacological (LINCS-SC) causes in the observed single-cell images. However, visual inspection of the resulting feature spaces via UMAP reveals observational environments as a prominent superstructure in our models' representations, whereas biological causes form secondary clusters within the local context of their parent observational environments as shown in FIG. 5. Consistently, LISI scores indicate poor integration over observational environments and performance deteriorates in kNN-CV. Critically, when tested on out of distribution-generalization, our naive baseline shows almost complete collapse across all three levels of generalization on GRID and level-3 for LINCS-SC.

Through experimental data, we find that SYM excels at purging variation over observational environments when assessing LISI-scores on the training set. However, for both GRID and LINCS-SC data, we find that this effect does not generalize even to independent and identically distributed validation data and performs poorly on all other metrics. We find that domain-adversarial-models achieve LISI-scores similar to SYM on GRID, while fully generalizing to independent and identically distributed data, and drastically improving kNN-CV scores. On LINCS-SC however, domain-adversarial yields only comparatively minor improvements in kNN-CV scores. Remarkably, despite these somewhat promising auxiliary metrics, domain-adversarial does not significantly improve out of distribution-generalization across any level in either dataset. Likely because StarGANv2 permutes both style and content (as shown in FIG. 2), predictors trained on the StarGANv2-generated distribution fail even at independent and identically distributed generalization. MixStyle on the other hand, yields excellent independent and identically distributed-performances but-presumably hampered by it's assumptions about what constitutes style-features—yields equally disappointing results in out of distribution tests.

By contrast, the interventional style transfer model learns to faithfully impute observations as if they had been made in different observational environments as shown in FIG. 4B. Qualitative inspection of output images suggests that the interventional style transfer model simultaneously preserves phenotypic content of the source images (as shown in FIG. 4C). As such, the interventional style transfer model is able to randomize over the confounder C (as shown in FIG. 4B) to yield a training distribution P(y,\hat{x},z|do(c)) in which the original correlations between observational environments and biological causes are diminished. Consistent with this, major performance gains are observed across all levels of out of distribution-generalization, as well as other metrics, for both GRID and LINCS-SC data, when predictors are trained on interventional style transfer-generated data-distributions (as shown in Table 1). These results suggest that the interventional style transfer model generates effective interventions on confounders and thereby promotes the emergence of causal representations of biological phenomena.

Table S1 illustrates macro f1-scores for additional baselines & ablations on GRID. A single (random) level-1 fold was assessed for ablations.

TABLE S1
Macro f1-scores for additional baselines & ablations on GRID.
A single (random) level-1 fold was assessed for ablations.

| | IID | Level-1 (vs Section 6) | Level-1 |
|---|---|---|---|
| 1. Baseline (ERM) | 0.55 | 0.1965 (−0.521) | 0.1877 |
| 2. IST (ours) | 0.6013 | 0.7176 (+0.000) | 0.5839 |
| 3. IST w/o [symbol] _{Cmatch} | 0.3961 | 0.2706 (−0.447) | — |
| 4. IST w/o [symbol] _{Style} | 0.6972 | 0.5885 (−0.122) | — |
| 5. IST w/o [symbol] _{Cycle} | 0.6426 | 0.7053 (−0.012) | — |
| 6. IST w/o [symbol] _{Cont} | 0.6149 | 0.7449 (+0.027) | — |
| 7. IST one-Img/OE | 0.6061 | 0.7315 (+0.014) | — |
| 8. Ours w/o test-time adapt. | 0.6046 | 0.5042 (−0.213) | — |

To provide further insight into key components of the interventional style transfer method, in a limited ablation study is provided, evaluating their effects on interventional style transfer model's ability to improve out of distribution generalization against a single level-1 fold of GRID (as shown in Table S1). Ablation of individual loss terms highlights L_{Cmatch} and L_{Style} as key components of our full objective, whereas ablation of L_{Cycle} has only a minor impact on performance. Removing L_{Cont} improved performance by 2 points. While this may suggest that discouraging alterations in pixel space through L_{Cont} may be too restrictive in this case, it is preferred to err on the side of caution, wary that the preservation of (phenotypic) content is vital to any applications of the interventional style transfer model in scientific discovery (combining ablations on “content” terms to check for redundancy). UNet skip-connections are introduced between the encoder and decoder branches of the interventional style transfer generator G as shown in FIGS. 4A-4C.

FIG. 5 illustrates substantially degraded interventional style transfer model-output image quality for an Interventional style transfer model with ablated UNet skip-connections. Images x_{α} and x_{β} are the same as in FIG. 4B. Therefore, training the interventional style transfer model without UNet skip-connections greatly deteriorates the quality of the resulting IST output images, as shown in FIG. 5.

The extent to which the performance of the interventional style transfer model depends on the number and diversity of style-target images available during inference is investigated. Particularly worrisome would be any evidence of content leakage from style-target images. Although the strategy by which style-targets are sampled during training, i.e. randomly balanced over both causes (class labels) and observational environments, is designed to avoid this, it could be insufficient. Instead, reducing the diversity of available style-targets during inference to even a single style-target image per observational environment, irrespective of their class labels, if anything, improves the ability of interventional style transfer models to produce effective interventional training distributions as shown in Table S1.

Finally, empirical evidence is provided for the benefit of projecting source images into the interventional style transfer-reference space for the performance of predictors trained on interventional style transfer-generated interventional distributions, as done by default in the experiments. The test time performance of interventional style transfer-trained predictors deteriorates substantially when evaluated directly on test images, although even here, interventional style transfer-predictors retain a large performance gain over other baselines.

The rationale behind the interventional style transfer method disclosed herein is guided by the idea that conventional models encode spurious correlations between confounding nuisances and causes in the training data and consequently fail to generalize to out of distribution data. How observational environments as confounders manifest in the complex single-cell fluorescent microscopy images are studied in this work however is not obvious even to human expert analysts. The empirical results in the main text notwithstanding, experiments are conducted on an easy-to-interpret synthetic dataset with perfectly known causes, confounders, correlations.

results on color-MNIST were obtained. In the training and independent and identically distributed-validation hold-out sets, pairs of digit-categories only ever encountered with one background color (observational environments), yielding five distinct pairs of digit-categories, and a training distribution that is strongly correlated with confounding nuisances. Interventional style transfer-imputed versions of images x_{α} (sampled from the validation set) based on environment-codes were extracted from the indicated images x_{β}. Confusion matrices were generated and UMAP visualizations of the representations \hat{Z} naive baseline or a predictor trained with interventional style transfer-imputation are seen. UMAPs were computed on training data. Either independent and identically distributed-validation or out of distribution-test data is shown. Data points in UMAPs were colored are by either cause (digit-category) or observational environment (background color). Due to dataset structure, no admixture of environments is expected for independent and identically distributed-validation data for either method.

A version of color-MNIST in which digits are confounded by background colors is constructed. Digit categories y∈{0, 1, 9} are used as causes and a confounder that introduces spurious correlations between causes and background colors as observational environments. The training and corresponding independent and identically distributed-validation sets are confounded by exclusively assigning five background colors k∈{green, blue, red, purple, yellow} to mutually exclusive pairs of digit categories. In contrast, the out of distribution-test set contains all combinations not found in the training/validation sets, thus simulating the extreme scenario in which test data contains causes observed exclusively in observational environments different to that of the training set. A predictor that learns to encode the spurious correlations in the training set, is expected to perform well on validation, but poorly (close to chance) on out of distribution-test data. If instead causal representations of the digit categories are learned, invariance to background color should allow the predictor to generalize well to both independent and identically distributed and out of distribution hold-out sets.

Contrary to experiments previously described, no augmentations or image-level normalizations are applied. The naive baseline predictor is trained on digit categories by empirical risk minimization. Next, the interventional style transfer model is trained to impute training-images as if they had been observed in different observational environments (i.e. background colors) and leverage the resulting generator to produce an interventional training distribution in which we expect correlations between causes and observational environments to be mitigated.

The naive baseline approach achieves excellent performance on hold-out data, as long as the confounding bias inherent to the training dataset is maintained. However, the naive baseline fails to achieve results better than chance on our out of distribution-test set. Inspection of UMAPs derived from representations \hat{Z} (as shown in FIG. 4A) illustrate how the naive baseline represents input images exclusively within the landmarks of their corresponding background colors: irrespective of digit-category, images with e.g. blue background fall onto the landmarks of digits that were encountered with blue background in the training set (two's and three's) as shown in FIG. 6D. Similar to results on real-world microscopy data reported in the main text, the Interventional style transfer model appears to directly represent the specific hierarchy underlying the training data, despite not having been trained explicitly to do so.

Therefore, the trained Interventional style transfer model generates reasonable imputations of source images x_{α} by virtue of extracted environment (style) codes from some images x_{β}.

Moreover, training a predictor based on the interventional style transfer-distribution P(X, Y|do(C) is effective in yielding representations that—in this case—fully generalize to out of distribution-test data, achieving performance on par with independent and identically distributed validation data. Consistently, when inspecting the representations \hat{Z} of the resulting interventional style transfer-predictor model, in UMAP space, there is no observable assortment of images according to background color for out of distribution-test data, and only by digit category.

Additional UMAP visualizations of \hat{Z} for Symphony and domain-adversarial baselines on GRID were effected. For training data, UMAP results for Symphony are especially compelling, with observational environments exhibiting close to complete admixture, while class-wise clustering remains largely preserved. However, these effects do not generalize well even to independent and identically distributed holdout data: despite somewhat improved cLISI/bLISI scores, Symphony deteriorates independent and identically distributed-generalization compared to the naive baseline and fails to improve either kNN-based CV or out of distribution-generalization scores across any level.

Gradient Reversal Layer (GRL) inverts the gradient emanating from the environment classifier for the parameters of the shared feature extractor (ResNet18 stem or other neural network). Hyperparameter tuning for domain-adversarial's alpha on independent and identically distributed hold-out set accuracy for causes vs. observational environments on GRID data.

Consistent with improved LISI scores, domain-adversarial mitigates the prominence of observational environments within UMAP visualizations in favor of biological causes. Still, observational environments remain apparent as substructures of causes. This raises the possibility that the choice of the regularization weight alpha may have been sub-optimal. This is due to the strength domain-adversarials' alpha parameter being tuned such that domain-adversarials' observational environments classification performance remains random (while maximizing performance on causes). Moreover, increasing observational environments alpha from 0.0625 to 1.0 has no noticeable effect on UMAP structure (data not shown), which argues against sub-optimal hyperparameter tuning as an explanation for domain-adversarials' failure to fully remove observational environments as a factor of variation learned by predictors. Other avenues, such as increasing capacity of the classification heads, the architecture of which, in the interest of fair comparison to our other baselines, was kept consistent across all experiments, may prove more fruitful.

A matrix of UMAPs visualizing causes (perturbations-categories) Y (left) and series-level observational environments C (right) for LINCS-SC data across all methods. Dimethyl sulfoxide (DMSO) indicates negative control. Inset highlights an indicated region of well-resolved data-points clustered by cause, and significant integration with the reference series.

Extended data on LINCS-SC were obtained. UMAPs of training-set representations of naive baseline models reveal dominant super-structure at the series-level (level-3). Just as for GRID, Symphony achieves strong integration over observational environments, however at substantial cost of preserving cause-specific phenotypic signal that identifies a subset of pharmacological perturbations from controls (as shown in Table 1).

In contrast to GRID, LINCS-SC contains only a single series that covers all perturbations (Ref-Series), but no replicate plate-maps, while four additional series cover subsets of perturbations over five replicate-plates, but share no perturbations between them (see FIG. 3C for reference). Consequently, we would not expect integration between non-reference series, even in perfectly causal representation, unless there was significant overlap between the morphological effects of the perturbations held between them. Identifying such points of phenotypic convergence between chemically disparate pharmacological agents is of great interest to the drug-development community, as it might make it possible to infer a new drug-candidates biological mechanisms of action (MOA) based on a visual readouts on (sub) cellular morphology. However, the perturbations in LINCS-SC have known mechanisms of action, with little-to-no overlap between them. Hence, integration is expected only between Ref-Series and each other series, but not among the latter.

Domain-adversarial-training has no observable impact on diminishing the dominance of series-level (level-3) observational environments in the UMAPs. However, consistent with quantitative results, we find substantially increased integration between Ref-Series and other series, when inspecting representations derived from predictors trained with the interventional style transfer model.

In embodiments, an interventional training distribution system includes, includes (a) a generator module, (b) an encoder module and (c) a machine learning module. In embodiments, the generator module, encoder module and machine learning module may be implemented using one or more processors operatively connected to memory, where the memory includes machine readable instructions, execute by the one or more processors. The one or more processors may include processing circuitry capable of controlling operations and functionality of the interventional training distribution model. For purposes of the present disclosure, each module may include its own local memory, which may store program systems, program data, and/or one or more operating systems configured to perform the functions thereof.

Learning visual features that generalize across environments is a critical prerequisite for real-world applications of machine learning systems in biomedicine, yet the field lacks broadly adopted metrics to assess progress towards this goal. The out of distribution-generalization tests are structured according to a hierarchy of technical processing steps that generally characterize the data generation process of most high-content imaging studies. Seemingly well-performing baselines, including state-of-the-art-methods for batch-effect correction, as assessed by independent and identically distributed hold-out sets and several auxiliary metrics, almost completely collapse on this benchmark, revealing highly confounded representations. The success of interventional style transfer instead shows that effective interventions to mitigate confounders can be learned. It is noted that even models trained on billions of diverse natural images have only achieved minor gains on ObjectNet, suggesting that scale alone is not efficient at breaking contextual biases. Conversely, the Interventional style transfer model provided herein bears semblance to thought experiments, by which humans routinely reevaluate familiar concepts in never-observed contexts, thus filling in a sparse matrix of actual observations.

What is claimed is:

1. A method for generating a training set for a machine leaning predictor comprising:
a) obtaining, by a machine learning module, a content image and a style image;
b) extracting, by an encoder module, one or more features from the content image;
c) extracting, by the encoder module, an observational environment from the style image;
d) deriving, by the encoder module, one or more latent representations from the one or more feature sets extracted from the content image;
e) deriving, by the encoder module, at least one style code based on the observational environment extracted from the style image;
f) generating, by a generator module, an interventional training distribution training set element based on the style code and the latent representation;
g) storing, by the generator module, the interventional training distribution training set element in a memory operable connected to the generating module and the encoder module; and
h) repeating steps a) through g) for a plurality of content images and a plurality of style images to provide an interventional training distribution training set.

2. The method of claim 1, further comprising providing a query to the machine learning predictor module, wherein the machine learning predictor module implements a machine learning algorithm trained using the interventional training distribution training set and generates an output associated with the latent image.

3. The method of claim 1, wherein the latent representations are associated with phenotypic content of a cell.

4. The method of claim 2, wherein the interventional training distribution training set is configured to identify relationships between feature sets of interest in one or more images independent of the observational environment associated with the features sets.

5. The method of claim 1, wherein the step of generating the interventional training distribution training set element includes producing, by the generator module, an image transformation including a first representation of a first image of the content image and an observational environment of a second image of the style image.

6. The method of claim 5, wherein the first representation is first phenotypic content of a cell.

7. The method of claim 1 wherein the step of generating the interventional training distribution training set element includes transforming, by the generator module, an appearance of a first image of the content image from a first observational environment of the first image to a second observational environment of a second image of the style image.

8. The method of claim 1, wherein the deriving step (d) further comprises deriving, by the encoder module, one or more latent representations from the one or more feature sets extracted from content image while maintain phenotypic information.

9. The method of claim 1, wherein the deriving step (e) further comprises deriving, by the encoder module, a style code from the respective observational environment extracted from the style image.

10. The method of claim 1, wherein the step of generating the interventional training distribution training set element includes implementing a loss function to maintain phenotypic information.

11. The method of claim 10, wherein the loss function is selected from a group consisting of: an adversarial loss function, a style loss function, a cycle-consistency loss function, a content loss function, and a class-matching loss function.

12. The method of claim 1, wherein the step of generating the interventional training distribution training set element includes balancing, by the generator module, content images over feature sets.

13. The method of claim 1, wherein the step of generating the interventional training distribution training set element includes balancing, by the generator module, style images over observational environments.

14. The method of claim 1, further comprising:
i) extracting, by the encoder module, second one or more features from the style image;
j) extracting, by the encoder module, a second observational environment from the content image;
k) deriving, by the encoder module, second one or more latent representations from the second one or more feature sets extracted from the style image;
l) deriving, by the encoder module, a second style code based on the second observational environment extracted from the style image;
m) generating, by a generator module, a second interventional training distribution training set element based on the second style code and the second one or more latent representations;
n) storing, by the generator module, the second interventional training distribution training set element in the memory.

15. A method for generating a training set for a machine learning predictor module based on a set of images comprising:
a) obtaining, by a machine learning module, the set of images, wherein the set of images includes content images and style images;
b) selecting, by the machine learning module, a first content image and a first style image form the set of images;
c) extracting, by an encoder module, one or more feature sets from the content image and an observational environment from the first style image;
d) deriving, by the encoder module, at least one latent image representation based on the one or more feature sets and at least one style code based on the observational environment;
e) generating, by a generator module, an interventional training distribution training set element based on the at least one latent image representation and the at least one style code;
f) storing, by the generator module, the interventional training distribution training set element in memory operably connected to the generator module; and
g) repeating steps b) through f) to provide an interventional training distribution training set in the memory.

16. The method of claim 15, further comprising providing a query to a machine learning predictor module implementing a machine learning algorithm trained by the interventional training distribution training set to generate an output associated with the latent image.

17. The method of claim 15, wherein the interventional training distribution training set includes at least one image having at least one preserved representation from the first content image and at least one observational environment from the first style image.

18. The method of claim 15, wherein the generating step includes providing an image transformation having first phenotypic content of the content image and a second observational environment of the style image.

19. The method of claim 15, wherein the generating step includes transforming, by the generator module, an appearance of a first image of the content image from a respective observational environment to another observational environment.

20. An interventional style transfer system comprising:
a) at least one processor; and
b) a memory, operably connected to the at least one processor, the memory includes processor executable code that when executed by the at least one processor executes steps of:
(i) obtaining a content image and a style image;
(ii) extracting one or more features from the content image;
(iii) extracting an observational environment from the style image;
(iv) deriving one or more latent representations from the one or more feature sets extracted from the content image;
(v) deriving at least one style code based on the observational environment extracted from the style image;
(vi) generating an interventional training distribution training set element based on the style code and the latent representation;
(vii) storing the interventional training distribution training set element in a memory operable connected to the generating module and the encoder module;
(viii) repeating steps (i) through (vii) for a plurality of content images and a plurality of style images to provide an interventional training distribution training set,
or
an interventional style transfer system comprising:
memory;
a machine learning module operatively connected to the memory and configured to obtain a content image and a style image;
an encoder module operably connected to the machine earning module and configured to:
(i) extract at least one feature set from the content image;
(ii) extract an observational environment from the style image;
(iii) derive a latent image representation based on the at least one feature set;
(iv) derive a style code based on the observational environment; and
a generator module operatively connected to the encoder module and configured to generate an interventional training distribution training set element based on the latent image representation and the style code,
wherein the interventional training distribution training set element is stored in the memory to provide an interventional training distribution training set,
wherein the interventional training distribution training set is used to train a machine learning predictor.
